(19) United States
(12) Patent Application Publication
(10) Pub. No.: US 2017/0076644 A1
(43) Pub. Date: Mar. 16, 2017

(54) DISPLAY DEVICE, METHOD OF DRIVING THE SAME, AND IMAGE DISPLAY SYSTEM

(71) Applicant: Samsung Display Co., Ltd., Yongin-Si (KR)

(72) Inventors: Gwangsoo AHN, Suwon-si (KR); Po-yun PARK, Seoul (KR); Hong-kyu KIM, Suwon-si (KR); Junghwan CHO, Asan-si (KR)

(21) Appl. No.: 15/139,821

(22) Filed: Apr. 27, 2016

(30) Foreign Application Priority Data
Sep. 11, 2015 (KR) 10-2015-0128888

(51) Int. Cl. G09G 3/00; G06T 1/60

(52) U.S. Cl. CPC G09G 3/00; G06T 1/60; G09G 2300/0439; G09G 2310/08; G09G 2330/021

(57) ABSTRACT

A display device includes a display panel, and a timing controller which includes a memory unit and an image data conversion unit where when a mode selection signal includes information about a first mode at an (n+1)th frame (n is a positive integer), the memory unit maintains a first frame image data stored before the (n+1)th frame among an image data, when the mode selection signal includes information about a second mode, the memory unit stores second frame image data inputted during the (n+1)th frame among the image data, and the image data conversion unit rearranges pixel data included in the data stored in the memory unit among the first frame image data and the second frame image data, and outputs converted image data.

This application claims priority to Korean Patent Application No. 10-2015-0128888, filed on Sep. 11, 2015, and all the benefits accruing therefrom under 35 U.S.C. §119, the content of which in its entirety is herein incorporated by reference.

### BACKGROUND

1. Field

Exemplary embodiments of the invention herein relate to a display device, a method of driving a display device, and an image display system, and more particularly to, a display device, a method of driving a display device, and an image display system capable of being implemented with low power and low costs.

2. Description of the Related Art

Display devices, such as a liquid crystal display device, an electrophoretic display device, and an organic light emitting display device, have been widely used to replace typical Braun tubes. A display device includes a display panel, a gate driver, and a data driver. The display panel includes gate lines, data lines, and pixels connected to the gate lines and data lines.

### SUMMARY

The invention provides a display device, a method of driving a display device, and an image display system capable of being implemented with low power and low costs.

An exemplary embodiment of the invention provides a display device including a display panel including a plurality of data lines extending in a first direction, a plurality of gate lines extending in a second direction crossing the first direction, and pixels, a timing controller which receives, from the outside, a control signal, image data, and a mode selection signal including information about one of a first mode which is a still image mode or a second mode which is a moving image mode, and outputs a gate control signal, data control signal, and converted image data, a gate driver from the outside generate a gate signal based on the basis of the gate control signal, and to output the gate signal to the plurality of gate lines, and a data driver which outputs a data voltage which is converted from the converted image data on the basis of the data control signal, wherein the timing controller includes a memory unit which maintains first frame image data stored before an (n+1)th frame from among the image data when the mode selection signal includes information about the first mode at the (n+1)th frame (n is a positive integer), and stores second frame image data inputted during the (n+1)th frame from among the image data when the mode selection signal includes information about the second mode, and an image data conversion unit which rearranges pixel data included in the data stored in the memory unit from among the first frame image data and the second frame image data, and to output the converted image data.

In an exemplary embodiment, the first frame image data and the second frame image data may correspond to one frame.

In an exemplary embodiment, the pixels may be arranged in a matrix shape along the first and second directions, the pixels may be defined as first pixel groups arranged along the second direction and second pixel groups arranged along the first direction, each of the first pixel groups may include pixels parallely arranged along the first direction, each of second pixel groups may include pixels parallely arranged along the second direction, in the image data, data corresponding to the first pixel groups may be sequentially arranged, and in the converted image data, data corresponding to the second pixel groups may be sequentially arranged.

In an exemplary embodiment, the image data conversion unit may sequentially extract data corresponding to each of the second pixel groups from the data stored in the memory unit from among the first frame image data and the second frame image data.

In an exemplary embodiment, number of pixel data included in each of the first pixel groups may be greater than number of pixel data included in each of the second pixel groups.

In an exemplary embodiment, the mode selection unit may output the mode selection signal including information about the first mode when the first frame image data and the second frame image data are substantially the same, and output the mode selection signal including information about the second mode when the first frame image data and the second frame image data are different from each other.

In an exemplary embodiment, the timing controller may further include a image data receiving unit which receives the image data and the mode selection signal, and the image data receiving unit may not receive the second frame image data when the mode selection signal including information about the first mode during the (n+1)th frame, and receive the second frame image data when the mode selection signal including information about the second mode during the (n+1)th frame.

In an exemplary embodiment, the memory unit may store the image data which the image receiving unit receives.

In an exemplary embodiment, when the image data receiving unit does not receive the second frame image data during the (n+1)th frame, the memory unit may store the first frame image data inputted to the image receiving unit before the (n+1)th frame, and when the image data receiving unit receives the second frame image data during the (n+1)th frame, the memory unit may store the second frame image data.

In an exemplary embodiment, each of the pixels may have a first width parallel to the first direction, and a second width parallel to the second direction, and the first width may be smaller than the second width.

In an exemplary embodiment, a distance between two data lines adjacent to each other among the plurality of data lines may is a first distance, and a distance between two gate lines adjacent to each other among the plurality of gate lines may is a second distance smaller than the first distance.

In an exemplary embodiment of the invention, a method for driving a display device including a display panel including a plurality of data lines, a plurality of gate lines, and pixels, the method include receiving, from the outside, a control signal, image data, and one of a first mode selection signal which is a still image mode, or a second mode selection signal which is a moving image mode, maintaining first frame image data stored before an (n+1)th frame among the image data when the first mode selection signal is inputted during the (n+1)th frame, and storing second frame image data inputted during the (n+1)th frame among the image data when the second mode selection signal is inputted during the (n+1)th frame, generating a converted image data by rearranging pixel data included in the data stored in the memory among the first frame image data and the second frame image data, and outputting, to the plurality of data lines, a data voltage, which is converted from the converted image data on the basis of a data control signal.

In an exemplary embodiment, the pixels may be arranged in a matrix shape along the first and second directions, the pixels may be defined as a first pixel groups arranged along the second direction and a second pixel groups arranged along the first direction, each of the first pixel groups may include pixels parallely arranged along the first direction, each of second pixel groups may include pixels parallely arranged along the second direction, in the image data, data corresponding to the first pixel groups may be sequentially arranged, and in the converted image data, data corresponding to the second pixel groups may be sequentially arranged.

In an exemplary embodiment, in the receiving of the image data, the second frame image data may not be received when the first mode selection signal is inputted, and the second frame image data may be received when the second mode selection signal is inputted.

In an exemplary embodiment, in the storing of the second frame image data may include storing received data among the image data in the memory, storing the first frame image data inputted before the (n+1)th frame in the memory when the second frame image data may not be received during the (n+1)th frame, and storing the second frame image data in the memory when the second frame image data is received during the (n+1)th frame.

In an exemplary embodiment of the invention, an image display system includes a display panel including a plurality of data lines extending in a first direction, a plurality of gate lines extending in a second direction crossing the first direction, and pixels, a graphic control unit outputting a control signal, image data, and a mode selection signal including information about one of a first mode which is a still image mode or a second mode which is a moving image mode, a timing controller which receives the control signal, the image data, and the mode selection signal, and outputs a gate control signal, a data control signal, and converted image data, a gate driver which generates a gate signal on the basis of the gate control signal, and to output the gate signal to the plurality of gate lines, and a data driver which outputs a data voltage which is converted from the converted image data on the basis of the data control signal, wherein the timing controller includes a memory unit which maintains first frame image data stored before an (n+1)th frame from among the image data when the mode selection signal includes information about the first mode at the (n+1)th frame (n is a positive integer), and to store second frame image data inputted during the (n+1)th frame from among the image data when the mode selection signal includes information about the second mode, and an image data conversion unit which rearranges pixel data included in the data stored in the memory unit from among the first frame image data and the second frame image data, and to output the converted image data.

In an exemplary embodiment, the graphic control unit may include a central processing unit providing the image data and the control signals, a mode selection unit which compares the first frame image data and the second frame image data among the image data to select the first mode or the second mode, and to output the mode selection signal including information about the selected mode, and an image data transmission unit which receives the mode selection signal, not to output the second frame image data when the mode selection signal includes information about the first mode, and outputs the second frame image data when the mode selection signal includes information about the second mode.

In an exemplary embodiment, the mode selection unit may output the mode selection signal including information about the first mode when the first frame image data and the second frame image data are substantially the same, and output the mode selection signal including information about the second mode when the first frame image data and the second frame image data are different from each other.

In an exemplary embodiment, the pixels may be arranged in a matrix shape along the first and second directions, the pixels may be defined as a first pixel groups arranged along the second direction and a second pixel groups arranged along the first direction, each of the first pixel groups may include pixels parallely arranged along the first direction, each of second pixel groups may include pixels parallely arranged along the second direction, in the image data, data corresponding to the first pixel groups may be sequentially arranged, and in the converted image data, data corresponding to the second pixel groups may be sequentially arranged.

In an exemplary embodiment, the image data conversion unit may sequentially extract data corresponding to each of the second pixel groups from the data stored in the memory unit among the first frame image data and the second frame image data.

### BRIEF DESCRIPTION OF THE DRAWINGS

The accompanying drawings are included to provide a further understanding of the invention, and are incorporated in and constitute a part of this specification. The drawings illustrate exemplary embodiments of the invention and, together with the description, serve to explain principles of the invention. In the drawings:

FIG. 1 is a schematic block diagram of an exemplary embodiment of a display device according to the invention;

FIG. 2 is an equivalent circuit diagram of one pixel illustrated in FIG. 1;

FIG. 3 is an internal block diagram of the graphic control unit illustrated in FIG. 1;

FIG. 4 is an internal block diagram of the timing controller illustrated in FIG. 1;

FIG. 5 is a plan view illustrating an exemplary embodiment of a portion of a display panel according to the invention;

FIG. 6 is a block diagram illustrating an exemplary embodiment of image data according to the invention;

FIG. 7 is a block diagram illustrating an exemplary embodiment of converted image data according to the invention; and

FIG. 8 is a flowchart illustrating an exemplary embodiment of an internal operation sequence of a timing controller according to the invention.

### DETAILED DESCRIPTION

The invention may be modified in several different forms, and specific embodiments will be exemplified in the drawings and described in detail. It is to be understood that the exemplary embodiment of invention is not limited to the disclosed embodiments, and is intended to cover various modifications and equivalent arrangements included within the spirit and scope of the invention, including the appended claims. Also, in the drawings, parts unrelated to the detailed description are not provided to ensure the clarity of the invention.

It will be understood that when an element is referred to as being “on” another element, it can be directly on the other element or intervening elements may be therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. In an exemplary embodiment, when the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, when the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the invention, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. In an exemplary embodiment, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the claims.

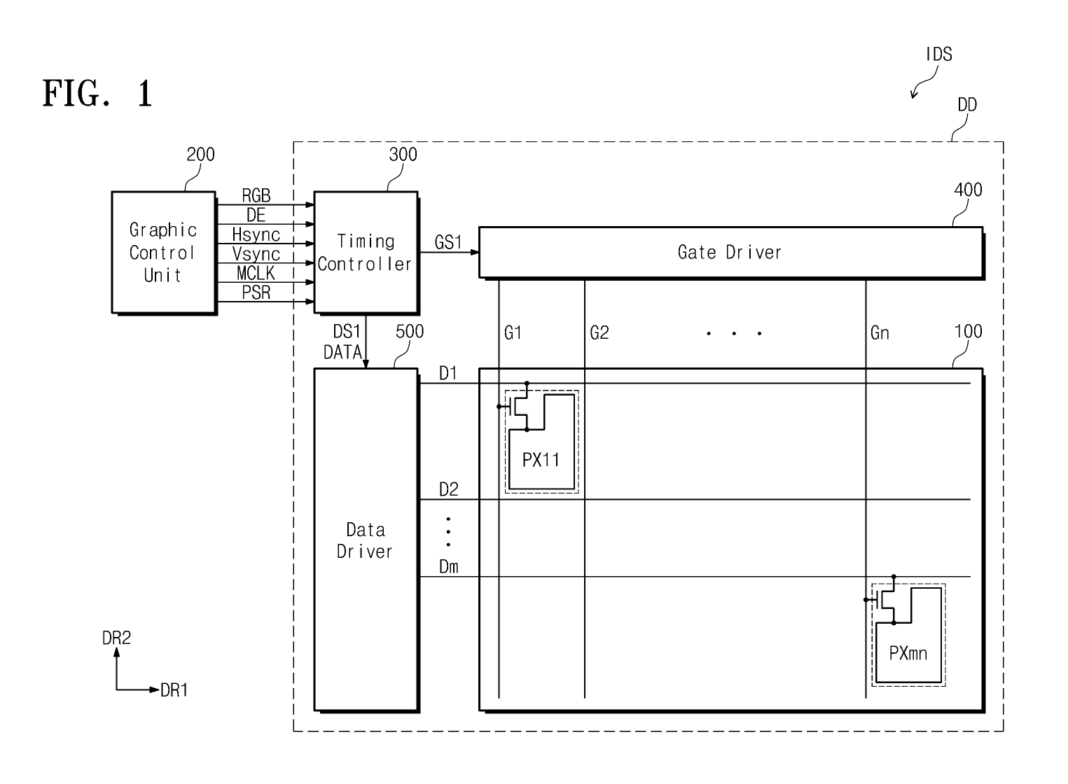

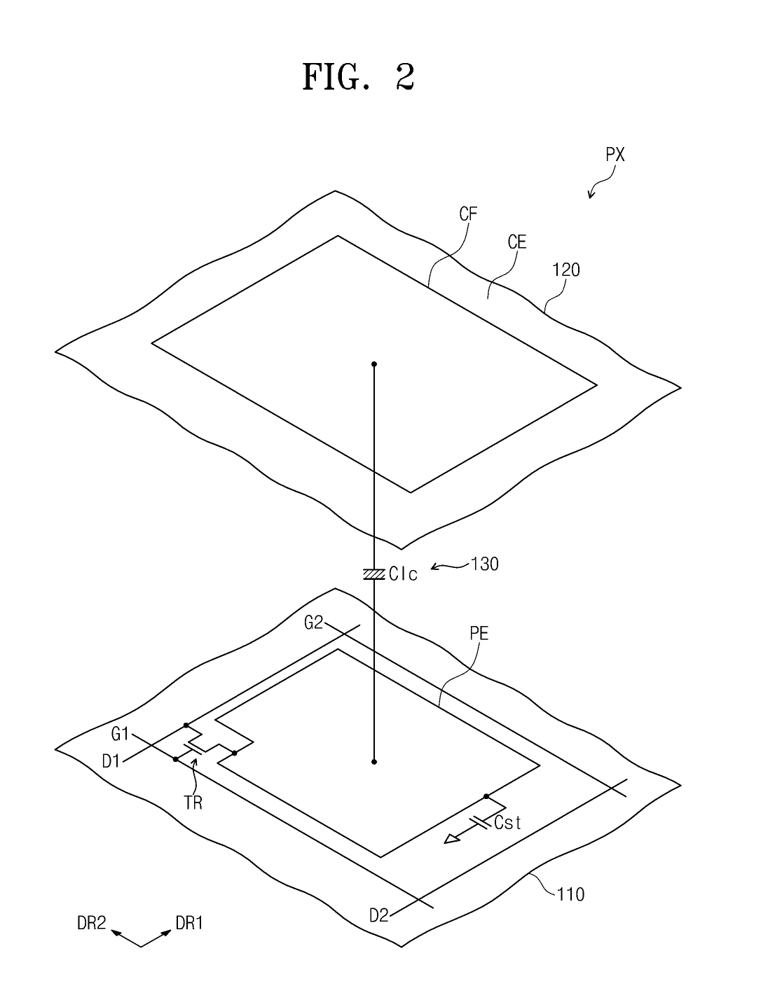

FIG. 1 is a schematic block diagram of a display device according to an exemplary embodiment of the invention, and FIG. 2 is an equivalent circuit diagram of one pixel illustrated in FIG. 1.

Referring to FIGS. 1 and 2, an image display system IDS may include a display device DD and a graphic control unit 200.

As an example of the image display system IDS, image display systems IDS may be provided to various electronic devices, such as televisions, laptop computers, and integrated computers, central information displays (“CIDs”) provided to a vehicle, and a small and medium sized image display systems, such as wristwatch type electronic apparatuses, personal digital assistants (“PDAs”), portable multimedia players (“PMPs”), game terminals, tablet personal computers (“PCs”), smart phones, vehicle navigation units, and cameras.

The display device DD may include a display panel 100, a timing controller 300, a gate driver 400, and a data driver 500.

In an exemplary embodiment, the display panel 100 may include various display panels, such as an organic light emitting display panel, a liquid crystal display (“LCD”) panel, a plasma display panel, an electrophoretic display panel, and an electro-wetting display panel. In the exemplary embodiment, a case in which the display panel 100 is an LCD panel will be described as an example.

The display panel 100 may include a first substrate 110, a second substrate 120 facing the first substrate 110, and a liquid crystal layer 130 disposed between the first substrate 110 and the second substrate 120. The liquid crystal layer 130 may include a plurality of liquid crystal molecules having arrangement states changed according to an electric field formed between the first and second substrates 110 and 120.

The display panel 100 may include a plurality of data lines D1 to Dm and a plurality of gate lines G1 to Gn. The plurality of data lines D1 to Dm may extend in a first direction DR1, and the plurality of gate lines G1 to Gn may extend in a second direction DR2 crossing the first direction DR1. The plurality of data lines D1 to Dm and the plurality of gate lines G1 to Gn may define pixel regions, and each of the pixel regions may be provided with a pixel PX displaying an image. In FIG. 1, a pixel PX11 connected to the first data line D1 and the first gate line G1 and a pixel PXmn connected to the m-th data line Dm and the n-th gate line Gn are illustrated as an example.

The pixel PX may include a thin film transistor (“TFT”) TR connected to the gate lines G1 to Gn, a liquid crystal capacitor Clc connected to the TFT TR, and a storage capacitor Cst parallely connected to the liquid crystal capacitor Clc. The storage capacitor Cst may not be provided, when necessary.

The thin-film transistor TR may be provided on the first substrate 110. A first electrode of the TFT TR may be connected to the first gate line G1, a second electrode of the TFT TR may be connected to the first data line D1, and a third electrode of the TFT TR may be connected to the liquid crystal capacitor Clc and the storage capacitor Cst.

The liquid crystal capacitor Clc has, as two terminals thereof, a pixel electrode PE disposed on the first substrate 110 and a common electrode CE disposed on the second substrate 120, and a liquid crystal layer 130 disposed between the pixel electrode PE and the common electrode CE functions as a dielectric. The pixel electrode PE may be connected to the thin-film transistor TR. The common electrode CE may be formed over the entire area of the second substrate 120, and receive a common voltage. Unlike in FIG. 2, the common electrode CE may also be provided on the first substrate 110, and in this case, at least one of the pixel electrode PE or the common electrode CE may be provided with a slit.

The pixel PX may express one of the primary colors or mixed colors. In an exemplary embodiment, the primary colors may include red, green, blue, and white, and the mixed colors may include various colors, such as yellow, cyan, magenta, for example. The pixel PX may further include a color filter CF expressing one of the primary colors or the mixed colors. In FIG. 2, an example in which the color filter CF is disposed on the second substrate 120 is illustrated, but exemplary embodiments of the invention are not limited thereto, and the color filter CF may be disposed on the first substrate 110.

The timing controller 300 may receive, from the graphic control unit 200 outside the display device DD, image data, control signals DE, Hsync, Vsync and MCLK, and a mode selection signal PSR.

The control signals DE, Hsync, Vsync and MCLK may include a vertical synchronization signal Vsync, which is a frame identification signal, a horizontal synchronization signal Hsync, which is a line identification signal, a data enable signal DE for indicating a region through which data enter, and a main clock signal MCLK.

The timing controller 300 converts an image data RGB to satisfy the specifications of the data driver 500, and outputs the converted image data DATA to the data driver 500. The timing controller 300 generates a gate control signal GS1 and a data control signal DS1. The timing controller 300 outputs the gate control signal GS1 to the gate driver 400, and outputs the data control signal DS1 to the data driver 500.

The gate control signal GS1 is a signal for driving the driver 400, and the data control signal DS1 is a signal for driving the data driver 500.

The gate driver 400 generates a gate signal on the basis of the gate control signal GS1, and outputs the gate signal to the gate lines G1 to Gn. In an exemplary embodiment, the gate control signal GS1 may include a scan start signal instructing a scan start, at least one clock signal controlling the period at which a gate-on voltage is outputted, and an output enable signal limiting the duration of the gate-on voltage, for example.

The data driver 500 generates a grayscale voltage corresponding to the converted image data DATA on the basis of the data control signal DS1, and outputs the gray scale voltage as a data voltage to the data lines D1 and Dm. The data voltage may include a positive polarity data voltage having a positive value and a negative polarity data voltage having a negative value, with respect to the common voltage. In an exemplary embodiment, the data control signal DS1 may include a horizontal start signal informing that the converted image data DATA begins to be transmitted to the data driver 500, a load signal instructing the providing of the data voltages to the data lines D1 through Dm, and an inverting signal inverting the polarities of the data voltages with respect to the common voltage, for example.

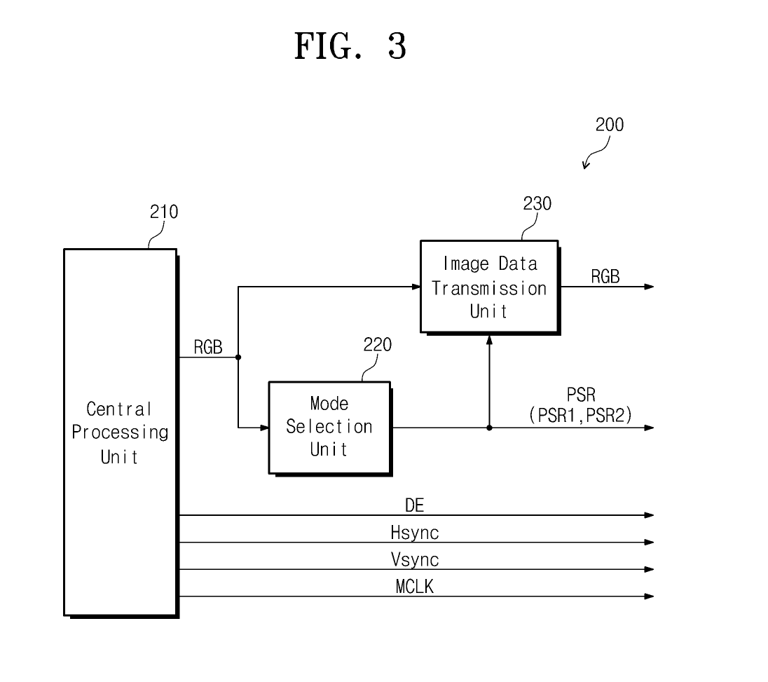

FIG. 3 is an internal block diagram of the graphic control unit illustrated in FIG. 1.

Referring to FIGS. 1 and 3, the graphic control unit 200 may include a central processing unit 210, a mode selection unit 220, and an image data transmission unit 230.

The central processing unit 210 generates the image data RGB and control signals DE, Hsync, Vsync, and MCLK. The central processing unit 210 may be implemented as a central processing unit CPU or an application processor AP, but exemplary embodiments of the invention are not limited thereto. The central processing unit 210 may output the image data RGB to the mode selection unit 220 and the image data transmission unit 230. The central processing unit 210 may output the control signals DE, Hsync, Vsync, and MCLK to the timing controller 300. Unlike the exemplary embodiments described above, in another exemplary embodiment of the invention, the control signals DE, Hsync, Vsync, and MCLK may also be outputted via the image data transmission unit 230 to the timing controller 300.

The mode selection unit 220 receives the image data RGB from the central processing unit 210. The mode selection unit 220 compares a first frame image data corresponding to an n-th frame and a second frame mage data corresponding to an (n+1)th frame, and outputs the mode selection signal PSR to the image data transmission unit 230 and the timing controller 300.

When the first frame image data and the second frame image data are substantially the same, the mode selection unit 220 determines the received image data RGB as a still image and outputs a first mode selection signal PSR1 including the information about a first mode, which is a still image mode. When the first frame image data and the second frame image data are different, the mode selection unit 220 determines the received image data RGB as a moving image and outputs a first mode selection signal PSR1 including the information about a first mode, which is a moving image mode.

The image data transmission unit 230 may receive the mode selection signal PSR from the mode selection unit 220, and output the image data RGB to the timing controller 300 in response to the mode selection signal.

In an exemplary embodiment, when the image data transmission unit 230 receives the first mode selection signal PSR1, the image data transmission unit 230 may stop operations, for example. That is, the image transmission unit 230 may not provide the timing controller 300 with the image data RGB. When the image data transmission unit 230 receives the second mode selection signal PSR2, the image data transmission unit 230 may transmit the image data RGB to the timing controller 300. That is, when the first frame image data corresponding to an n-th frame and the second frame image data corresponding to an (n+1)th frame are the same, the image data transmission unit 230 may stop operations and, as a result, power consumption may be reduced.

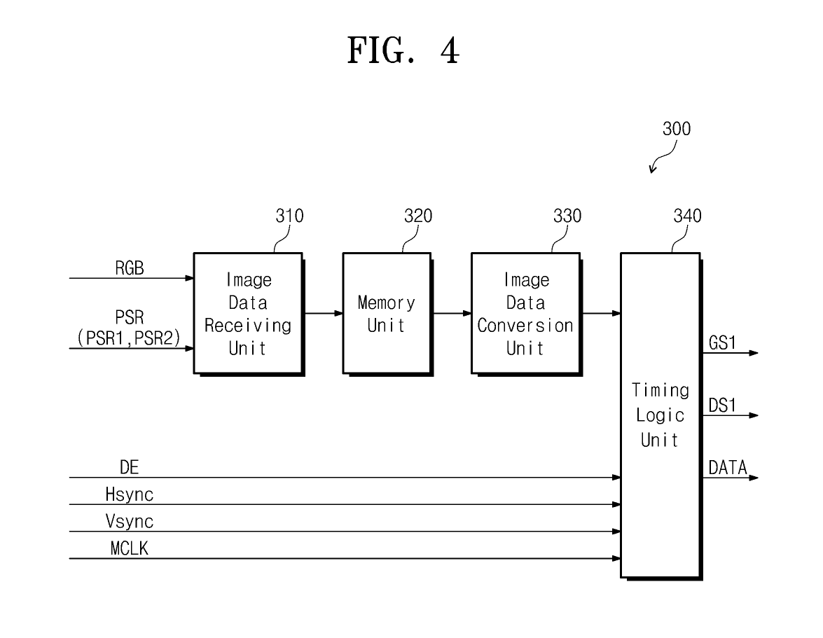

FIG. 4 is an internal block diagram of a timing controller illustrated in FIG. 1.

Referring to FIGS. 3 and 4, the timing controller 300 may include an image data receiving unit 310, a memory unit 320, an image data conversion unit 330, and a timing logic unit 340.

Hereinafter, for convenience of description, image data RGB inputted to the image data transmission unit 230 during an n-th frame is defined as a first frame image data, and image data RGB inputted to the image data transmission unit 230 during an (n+1)th frame is defined as a second frame image data. The first frame image data may be the data corresponding to n-th frame, and the second frame image data may be the data corresponding to (n+1)th frame.

The image data receiving unit 310 receives image data RGB provided from the data transmission unit 230. The image data receiving unit 310 may not receive the image data RGB from the image data transmission unit 230 when the first mode selection signal PSR1 is inputted. Also, the image data receiving unit 310 may receive the image data RGB from the image data transmission unit 230 when the second mode selection signal PSR2 is inputted. The image data receiving unit 310 may provide the memory unit 320 with the image data RGB inputted in response to the second mode selection signal PSR2. In an exemplary embodiment, when the image data receiving unit 310 receives the second frame image data and the second mode selection signal PSR2 during the (n+1)th frame, the image data receiving unit 310 may provide the memory unit 320 with the second frame image data, for example.

The memory unit 320 may store data corresponding to one frame. The memory unit 320 may include a volatile memory element such as a dynamic random-access memory (“DRAM”), and a non-volatile memory element such as a flash memory. In an exemplary embodiment, the memory unit 320 may include a DRAM, a phase-change random-access memory (“PRAM”), an magnetic random access memory (“MRAM”), a resistive random-access memory (“ReRAM”), a ferro-electric random-access memory (“FRAM”), a NOR flash memory, a NAND flash memory, and fusion flash memory, e.g., a memory in which a static random-access memory (“SRAM”) buffer and a NAND flash memory is combined, etc. However, exemplary embodiments of the invention are not limited thereto.

During the n-th frame, the image data receiving unit 310 receives the second mode selection signal PSR2 and the image data RGB. Since the second mode selection signal PSR2 is inputted to the image data receiving unit 310, the first frame image data may be stored into the memory unit 320.

During the (n+1)th frame, the image data receiving unit 310 receives the first mode selection signal PSR1. At this time, since the image data transmission unit 230 stops operations by the first mode selection signal PSR1, the image data receiving unit 310 does not receive the image data RGB inputted to the image data transmission unit 230 during the (n+1)th frame. According to the above-mentioned example, the first frame image data and the second frame image data corresponding to the n-th frame and the (n+1)th frame are the same. Accordingly, the timing controller 300 may output, during the (n+1)th frame, a converted image data DATA corresponding to the first frame image data stored in the memory unit 320. This is referred to as panel self refresh.

Unlike the example described above, a case in which the image data receiving unit 310, during the (n+1)th frame, receives the second mode selection signal PSR2 will be described as an example. During the (n+1)th frame, the image data receiving unit 310 may receive the second mode selection signal PSR2 and the second frame image data. Since the second mode selection signal PSR2 is inputted, the image data receiving unit 310 may provide the memory unit 320 with the second frame image data. Accordingly, the memory unit 320 may store the second frame image data.

The image data conversion unit 330 may re-arrange the pixel data included in the image data RGB stored in the memory unit 320 to output the converted image data DATA.

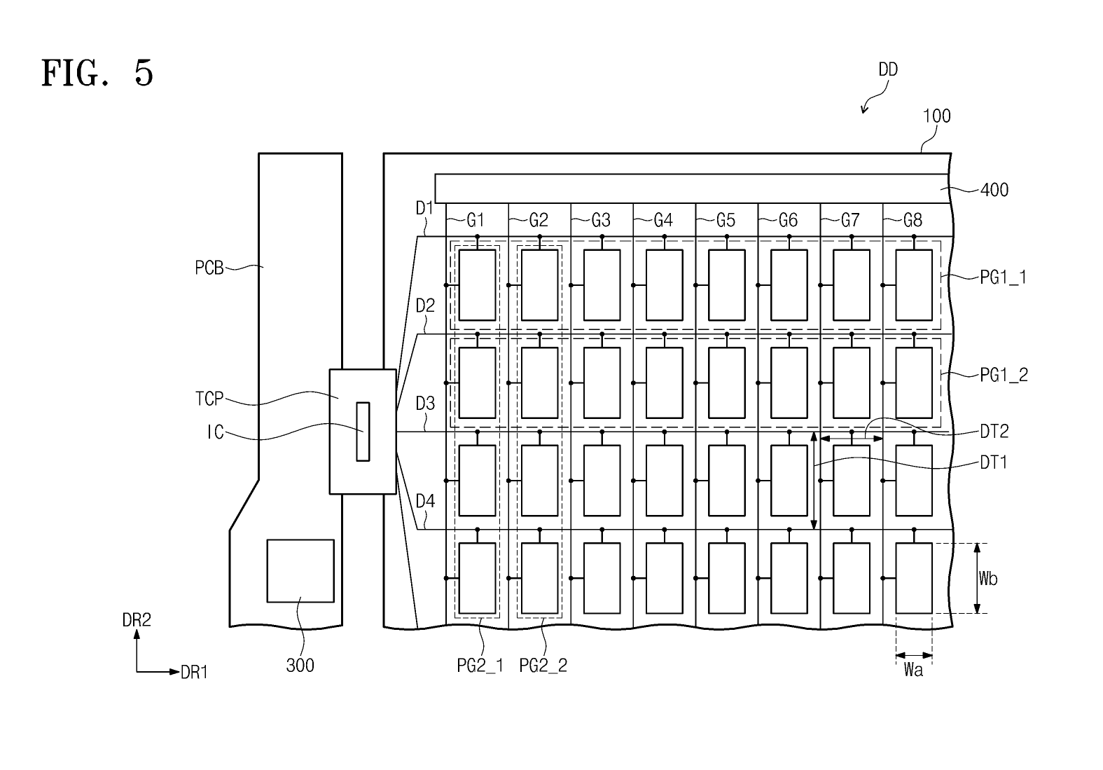

The output sequence of pixel data which are included in the image data RGB inputted from the graphic control unit 200 and the output sequence of pixel data which are included in the converted image data DATA may be different from each other. Accordingly, the image data conversion unit 330 may extract and re-arrange the pixel data from the image data RGB stored in the memory unit 320, and generate the converted image data DATA. This will be specifically described with reference to FIGS. 5 to 7.

The timing logic unit 340 generates a gate control signal GS1 and a data control signal DS1 in response to control signals DE, Hsync, Vsync, and MCLK. Although the image data conversion unit 330 and the timing logic unit 340 are separately illustrated in FIG. 4, the image data conversion unit 330 may also be included in the timing logic unit 340.

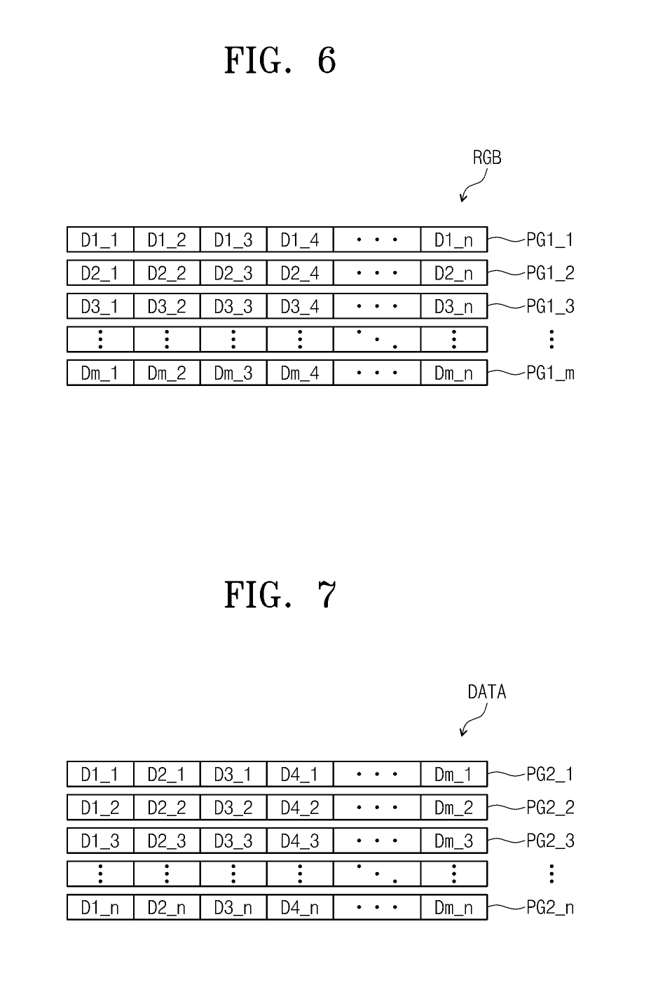

FIG. 5 is a plan view illustrating a portion of a display panel according to an exemplary embodiment of the invention, FIG. 6 is a block diagram illustrating image data according to an exemplary embodiment of the invention, and FIG. 7 is a block diagram illustrating converted image data according to an exemplary embodiment of the invention.

Referring to FIGS. 1 and 5, in the exemplary embodiment, a gate driver 400 may be mounted in the form of an amorphous silicon TFT gate driver circuit (“ASG”) on a non-display region of a display panel 100. In another exemplary embodiment of the invention, the gate driver 400 may be disposed on the non-display region through a chip on glass (“COG”) method, for example.

A data driver 500 may be mounted on a tape carrier package TCP in the form of a driving chip IC. One end of the tape carrier package TCP may be attached to the display panel 100, and the other end of the tape carrier package TCP may be connected to a printed circuit board PCB on which a timing controller 300 is mounted.

The distance between two data lines adjacent to each other among data lines D1 to Dm may be greater than the distance between two gate lines adjacent to each other among gate lines G1 to Gn. In FIG. 5, for example, the distance between the third data line D3 and the fourth data line D4 is defined as a first distance DT1, and, the distance between the seventh gate line G7 and the eighth gate line G8 is defined as a second distance DT2. Here, the first distance DT1 is greater than the second distance DT2.

Each of pixels PX11 to PXnm may have a first width Wa parallel to a first direction DR1 and a second width Wb parallel to a second direction DR2. The first width Wa may be smaller than the second width Wb. That is, the short side of each of the pixels PX11 to PXnm may extend in the first direction that is the same as the data lines D1 to Dm, and the long side of each of the pixels PX11 to PXnm may extend in the second direction that is the same as the gate lines G1 to Gn.

Unlike the exemplary embodiments of the invention described above, in the case in which the data lines (not shown) extends in the second direction DR2 and the distance between two data lines adjacent to each other among the data lines is greater than the first width Wa, the number of data lines may be greater in comparison with the exemplary embodiments of the invention. Accordingly, the number of driving chips IC may be increased. Also, unlike the exemplary embodiments of the invention, in the case in which the data lines (not shown) extends in the second direction DR2 and each of pixels (not shown) are rotated 90 degrees and the first width Wa is made to be greater than the second width Wb, the number of data lines may be decreased. However, when a diagonal image is displayed, readability may be decreased due to a pixel structure in which the first width Wa is greater than the second width Wb. Particularly, such a phenomenon may cause a limitation when displaying texts.

However, according to exemplary embodiments of the invention, the data lines D1 to Dm extends in the first direction DR1 and is arranged along the second direction DR2. Also, each of the pixels PX11 to PXnm has the first width Wa smaller than the second width Wb. Accordingly, the number of the data lines D1 to Dm may be decreased in comparison with the above-mentioned case in which the data lines extend in the second direction DR2. Also, since the first width Wa is smaller than the second width Wb, the phenomenon of decreased readability may be prevented.

Referring to FIG. 6, pixel data D1_1 to Dm_n included in image data RGB may be arranged in a sequence of being inputted into data lines extending in a second direction DR2. Accordingly, when image data RGB are converted as it is, and transmitted to the display panel 100, an image different from an image to display may be displayed. Accordingly, the pixel data of the image data RGB should be re-arranged.

In the exemplary embodiment, to re-arrange the pixel data D1_1 to Dm_n of the image data RGB, a memory for self refresh driving may be used. Accordingly, without additional memories, the pixel data may be re-arranged with a memory included in a timing controller capable of performing panel self refresh driving.

As described above, the image data RGB corresponding to one frame to be outputted during each frame is stored in the memory unit 320. FIG. 6 exemplarily illustrates the image data corresponding to one frame stored in the memory unit 320. The image data RGB may include the pixel data D1_1 to Dm_n. The first pixel data D1_1 is the datum corresponding to the first pixel PX11, and the mn-th pixel data Dm_n may be the data corresponding to the mn-th pixel PXmn.

The pixels PX11 to PXmn are arranged in a matrix shape along the first direction DR1 and the second direction DR2. The pixels PX11 to PXmn may be defined as first pixel groups PG1_1 to PG1_m and second pixel groups PG2_1 to PG2_n. Each of the first pixel groups PG1_1 to PG1_m includes pixels arranged along the first direction DR1, and each of the second pixel groups PG2_1 to PG2_n includes pixels arranged along the second direction DR2. The first pixel groups PG1_1 to PG1_m may be arranged along the second direction DR2, and the second pixel groups PG2_1 to PG2_n may be arranged along the first direction DR1.

Regarding the first pixel groups PG1_1 to PG1_m, although FIG. 5 illustrates reference numbers for only two first pixel groups PG1_1 and PG1_2, a total of m first pixel groups PG1_1 to PG1_m may be defined. Also, regarding the second pixel groups PG2_1 to PG2_n, although reference numbers for only two second pixel groups PG2_1 and PG2_2, a total of n second pixel groups PG2_1 to PG2_n may be defined.

The number of pixel data included in each of the first pixel groups PG1_1 to PG1_m may be greater than the number of pixel data included in each of the second pixel groups PG2_1 to PG2_n.

Referring to FIG. 6, the pixel data corresponding to the first pixel groups PG1_1 to PG1_m may be sequentially arranged in the image data RGB. Referring to FIG. 7, in the converted mage data DATA, the pixel data corresponding to the second pixel groups PG2_1 to PG2_n may be sequentially arranged.

The image data conversion unit 330 may extract the data corresponding to each of the second pixel groups PG2_1 to PG2_n sequentially from the memory unit 320 (refer to FIG. 4) and generate the converted image data DATA.

Although the converted image data DATA and the image data RGB may be the same in terms of including the pixel data D1_1 to Dm_n, the arrangement sequence of the pixel data D1_1 to Dm_n may be different from each other.

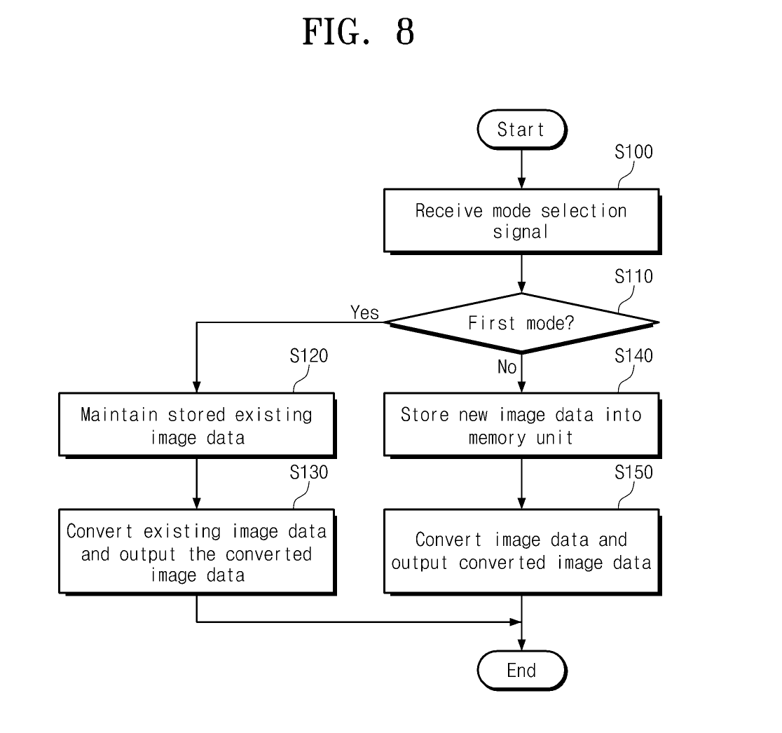

FIG. 8 is a flowchart illustrating an internal operation sequence of a timing controller according to an exemplary embodiment of the invention.

Referring to FIGS. 4 and 8, the image data receiving unit 310 receives a mode selection signal PSR (S100). The image data receiving unit 310 determines whether the mode selection signal PSR includes information about a first mode (S110).

When the first mode is selected, the image data receiving unit 310 does not receive new image data RGB. The memory unit 320 maintains the existing stored image data because the image data receiving unit 310 does not receive a new image data RGB (S120). The image data conversion unit 330 converts the existing image data stored in the memory unit 320 and outputs a converted image data DATA (S130).

When a second mode, which is different from the first mode, is selected, the image data receiving unit 310 receives new image data RGB. The memory unit 320 stores the new image data RGB (S140). The image data conversion unit 330 converts the new image data stored in the memory unit 320 and outputs a converted image data DATA (S150).

According to exemplary embodiments of the invention, the image display system IDS (refer to FIG. 1) may reduce power consumption through panel self refresh driving. Also, since a memory for the PSR driving is used to re-arrange the arrangement sequence of the pixel data included in the image data RGB received from a graphic control unit 200 (refer to FIG. 1), additional memories are not required and thus manufacturing costs may be reduced.

According to the invention, a display device and an image display system may reduce power consumption through a panel self refresh function. Also, pixel data may be re-arranged without additional memories, and thus the cost for manufacturing a display device and an image display system may be reduced.

It will be apparent to those skilled in the art that various modifications and variations can be made in the invention. Thus, it is intended that the invention covers the modifications and variations of this invention provided they come within the scope of the appended claims and their equivalents. Therefore, the scope of the invention is defined not by the detailed description of the invention but by the claims.

What is claimed is:

1. A display device comprising:
a display panel including a plurality of data lines extending in a first direction, a plurality of gate lines extending in a second direction crossing the first direction, and pixels;
a timing controller which receives, from an outside, a control signal, image data, and a mode selection signal including information about one of a first mode which is a still image mode or a second mode which is a moving image mode, and outputs a gate control signal, data control signal, and converted image data;
a gate driver which generates a gate signal based on the gate control signal, and outputs the gate signal to the plurality of gate lines; and
a data driver which outputs a data voltage which is converted from the converted image data based on the data control signal,
wherein
the timing controller includes:
a memory unit which maintains first frame image data stored before an (n+1)th frame (n is a positive integer) among the image data when the mode selection signal includes information about the first mode at the (n+1)th frame, and stores second frame image data inputted during the (n+1)th frame among the image data when the mode selection signal includes information about the second mode; and
an image data conversion unit which rearranges pixel data included in data stored in the memory unit among the first frame image data and the second frame image data, and outputs the converted image data.

2. The display device of claim 1, wherein the first frame image data and the second frame image data correspond to one frame.

3. The display device of claim 1, wherein
the pixels are arranged in a matrix shape along the first direction and the second direction;
the pixels are defined as first pixel groups arranged along the second direction and second pixel groups arranged along the first direction;
each of the first pixel groups includes pixels parallely arranged along the first direction;
each of second pixel groups includes pixels parallely arranged along the second direction;
in the image data, data corresponding to the first pixel groups are sequentially arranged; and
in the converted image data, data corresponding to the second pixel groups are sequentially arranged.

4. The display device of claim 3, wherein the image data conversion unit sequentially extracts data corresponding to each of the second pixel groups from the data stored in the memory unit among the first frame image data and the second frame image data.

5. The display device of claim 3, wherein number of pixel data included in each of the first pixel groups is greater than number of pixel data included in each of the second pixel groups.

6. The display device of claim 1, wherein
when the first frame image data and the second frame image data are substantially the same, the timing controller receives the mode selection signal including information about the first mode, and
when the first frame image data and the second frame image data are different from each other, the timing controller receives the mode selection signal including information about the second mode.

7. The display device of claim 1, wherein
the timing controller further includes a image data receiving unit configure to receive the image data and the mode selection signal; and
the image data receiving unit does not receive the second frame image data when the mode selection signal includes information about the first mode during the (n+1)th frame, and receives the second frame image data when the mode selection signal includes information about the second mode during the (n+1)th frame.

8. The display device of claim 7, wherein the memory unit stores the image data which the image receiving unit receives.

9. The display device of claim 8, wherein
when the image data receiving unit does not receive the second frame image data during the (n+1)th frame, the memory unit stores the first frame image data inputted to the image receiving unit before the (n+1)th frame, and
when the image data receiving unit receives the second frame image data during the (n+1)th frame, the memory unit stores the second frame image data.

10. The display device of claim 1, wherein each of the pixels has a first width parallel to the first direction, and a second width parallel to the second direction, and the first width is smaller than the second width.

11. The display device of claim 1, wherein a distance between two data lines adjacent to each other among the plurality of data lines is a first distance, and a distance between two gate lines adjacent to each other among the plurality of gate lines is a second distance smaller than the first distance.

12. A method for driving a display device including a display panel including a plurality of data lines, a plurality of gate lines, and pixels, the method comprising:
receiving, from an outside, a control signal, image data, and one of a first mode selection signal which is a still image mode or a second mode selection signal which is a moving image mode;
maintaining first frame image data stored before an (n+1)th frame among the image data when the first mode selection signal is inputted during the (n+1)th frame, and storing second frame image data inputted during the (n+1)th frame among the image data when the second mode selection signal is inputted during the (n+1)th frame;
generating a converted image data by rearranging pixel data included in the data stored in the memory among the first frame image data and the second frame image data; and
outputting, to the plurality of data lines, a data voltage which is converted from the converted image data based on a data control signal.

13. The method for driving a display device of claim 12, wherein
the pixels are arranged in a matrix shape along a first direction and a second direction crossing the first direction;
the pixels are defined as a first pixel groups arranged along the second direction and a second pixel groups arranged along the first direction;
each of the first pixel groups includes pixels parallely arranged along the first direction;
each of the second pixel groups includes pixels parallely arranged along the second direction;
in the image data, data corresponding to the first pixel groups are sequentially arranged; and
in the converted image data, data corresponding to the second pixel groups are sequentially arranged.

14. The method for driving a display device of claim 12, wherein in the receiving the image data, the second frame image data is not received when the first mode selection signal is inputted, and the second frame image data is received when the second mode selection signal is inputted.

15. The method for driving a display device of claim 14, wherein the storing the second frame image data comprises:
storing received data among the image data in the memory;
storing the first frame image data inputted before the (n+1)th frame in the memory when the second frame image data is not received during the (n+1)th frame; and
storing the second frame image data in the memory when the second frame image data is received during the (n+1)th frame.

16. An image display system comprising:
a display panel including a plurality of data lines extending in a first direction, a plurality of gate lines extending in a second direction crossing the first direction, and pixels;
a graphic control unit outputting a control signal, image data, and a mode selection signal including information about one of a first mode which is a still image mode or a second mode which is a moving image mode;
a timing controller which receives the control signal, the image data, and the mode selection signal, and outputs a gate control signal, a data control signal, and converted image data;
a gate driver which generates a gate signal based on the gate control signal, and outputs the gate signal to the plurality of gate lines; and
a data driver which outputs a data voltage which is converted from the converted image data based on the data control signal, wherein
the timing controller includes:
a memory unit which maintains first frame image data stored before an (n+1)th frame (n is a positive integer) among the image data when the mode selection signal includes information about the first mode at the (n+1)th frame, and stores second frame image data inputted during the (n+1)th frame among the image data when the mode selection signal includes information about the second mode; and
an image data conversion unit which rearranges pixel data included in data stored in the memory unit among the first frame image data and the second frame image data, and outputs the converted image data.

17. The image display system of claim 16, wherein the graphic control unit comprises:
a central processing unit which provides the image data and the control signals;
a mode selection unit which compares the first frame image data and the second frame image data among the image data to select the first mode or the second mode, and to output the mode selection signal including information about the selected mode; and
an image data transmission unit which receives the mode selection signal, not to output the second frame image data when the mode selection signal includes information about the first mode, and to outputs the second frame image data when the mode selection signal includes information about the second mode.

18. The image display system of claim 17, wherein the mode selection unit outputs the mode selection signal including information about the first mode when the first frame image data and the second frame image data are substantially the same, and outputs the mode selection signal including information about the second mode when the first frame image data and the second frame image data are different from each other.

19. The image display system of claim 16, wherein
the pixels are arranged in a matrix shape along the first and second directions;
the pixels are defined as a first pixel groups arranged along the second direction and a second pixel groups arranged along the first direction;
each of the first pixel groups includes pixels parallely arranged along the first direction;
each of second pixel groups includes pixels parallely arranged along the second direction;
in the image data, data corresponding to the first pixel groups are sequentially arranged; and
in the converted image data, data corresponding to the second pixel groups are sequentially arranged.

20. The image display system of claim 19, wherein the image data conversion unit sequentially extracts data corresponding to each of the second pixel groups from the data stored in the memory unit among the first frame image data and the second frame image data.
